(19) United States
(12) Patent Application Publication
(10) Pub. No.: US 2022/0408725 A1
(43) Pub. Date: Dec. 29, 2022

(54) NEW DEFOLIANT AND APPLICATION THEREOF

(71) Applicant: CHENGDU NEWSUN CROP SCIENCE CO., LTD., Chengdu, Sichuan (CN)

(72) Inventors: Qiming HE, Chengdu (CN); Baojin GONG, Chengdu (CN); Tingzhuo CHEN, Chengdu (CN); Bo DU, Chengdu (CN); Yong JIANG, Chengdu (CN); Dan REN, Chengdu (CN); Lin ZHAO, Chengdu (CN); Jie HE, Chengdu (CN); Yanqiong YANG, Chengdu (CN)

(73) Assignee: CHENGDU NEWSUN CROP SCIENCE CO., LTD., Chengdu, Sichuan (CN)

(21) Appl. No.: 17/791,839

(22) PCT Filed: Dec. 3, 2020
(86) PCT No.: PCT/CN2020/133508

§ 371 Date: Jul. 8, 2022

(30) Foreign Application Priority Data
Jan. 17, 2020 (CN) 202010054059.4

(51) Int. Cl. A01N 31/02; A01N 57/20; A01P 13/00; A01N 25/04; A01N 25/30

(52) U.S. Cl. CPC A01N 31/02; A01N 57/20; A01P 13/00; A01N 25/04; A01N 25/30

(57) ABSTRACT

A new type of defoliant and the application thereof, specifically the application of a polyether compound in the preparation of defoliant, belonging to the technical field of pesticides. At least one of the polyether compound shown in Formula I (R₁O(CH₂CHOH)ₙR₂) or salts thereof is used for preparation of defoliants or defoliation synergists, wherein, the R₁ is a hydrocarbyl or a phenolic group; the R₂ is —H, —O(CH₂CHOH)ₘH or —O(CH₂CH₂CHOH)ₘH; the n is 1-50, and m is 1-50. The compound is a new defoliant featured with low cost, convenient usage and favorable defoliation effect, and it is safe for the environment.

### CROSS-REFERENCE TO RELATED APPLICATIONS

The application claims the right and priority of the Chinese patent application CN 2020100540594 filed on Jan. 17, 2020, which is incorporated herein in its entirety by reference and for all other purposes.

### FIELD OF THE INVENTION

The invention relates to a new type of defoliant and the application thereof, and specifically to the application of a polyether compound in the preparation of defoliant, belonging to the technical field of pesticides.

### BACKGROUND OF THE INVENTION

Mechanical harvesting of fruit often requires defoliation. The influence of defoliants on the fruit should be minimized, and the fruit abscission rate should also be minimized during defoliation.

Fatty alcohol polyoxyethylene ether (AEO), also known as polyoxyethylene fatty alcohol ether, is the most rapidly developed and most commonly used non-ionic surfactant. This type of surfactant is an ether formed by condensation of ethylene oxide or propylene oxide with aliphatic alcohol, which is represented by the following general formula: RO(CH₂CH₂O)ₙH. In the formula, R is generally saturated or unsaturated C12-18 hydroxyl groups, which can be either straight-chain or branched-chain groups; n is the addition number of ethylene oxide, that is, the number of oxyethylene groups in the surfactant molecule. A larger n represents more oxygen on the hydrophilic group of the molecule, which leads to more hydrogen bonds formed with water and better water solubility.

Fatty alcohol polyoxyethylene ether (AEO) is often used as a surfactant in insecticide and fungicide products to increase wettability and penetration and improve performance of the products. As a surfactant, its amount added in the product formula is usually 5-10%, and its concentration is 0.025-0.05%.

### SUMMARY OF THE INVENTION

The first technical problem to be solved by the invention is to provide an application of polyoxyethylene ether in defoliant or defoliation synergist.

In order to solve the first technical problem of the invention, at least one of a polyether compound shown in Formula I or salts for preparation of a defoliant or a defoliation synergist,

R₁O(CH₂CHOH)ₙR₂ I

wherein, the R₁ is a hydrocarbyl or a phenolic group;

the R₂ is —H, —O(CH₂CHOH)ₘH or —O(CH₂CH₂CHOH)ₘH;

the n is 1-50, and m is 1-50;

and the salt is preferably a sulphonate or a phosphate.

The salt can be formed based on any position containing a hydroxyl group on R₁O(CH₂CHOH)ₙR₂.

In a specific embodiment, the cation of the salt is potassium, sodium or ammonium.

In a specific embodiment, the R₁ is a C2-50 hydrocarbyl, preferably a C8-22 hydrocarbyl, and more preferably a C12-18 hydrocarbyl.

In a specific embodiment, the R₂ is —H;

or the R₂ is —O(CH₂CHOH)ₘH, wherein, the n is 2-30, m is 1-30; preferably, n is 2-20, m is 1-20; further preferably, n is 3-9, m is 3-9; and more preferably, n is 3, m is 3;

or the R₂ is —O(CH2CH2CHOH)ₘH, wherein, the n is 2-30, m is 1-30; preferably, n is 2-20, m is 1-20; further preferably, n is 3-9, m is 3-9; and more preferably, n is 3, m is 3.

In a specific embodiment, the n is 2-30, more preferably 2-20, and further preferably 3-9.

In a specific embodiment, the n is 3, 5, 7 or 9, and preferably 5.

For example, R₁O(CH₂CHOH)₃H, R₁O(CH₂CHOH)₅H, R₁O(CH₂CHOH)₇H or R₁O(CH₂CHOH)₉H. R₁ is a hydroxyl group, for example, R₁ is C12-18.

In a specific embodiment, at least one of R₁O(CH₂CHOH)₃H, R₁O(CH₂CHOH)₇H and R₁O(CH₂CHOH)₉H is used in combination with R₁O(CH₂CHOH)₅H; preferably, R₁O(CH₂CHOH)₇H is used in combination with R₁O(CH₂CHOH)₅H.

At least one of R₁O(CH₂CHOH)₃H, R₁O(CH₂CHOH)₇H and R₁O(CH₂CHOH)₉H is used in combination with R₁O(CH₂CHOH)₅H in any proportion.

In a specific embodiment, the concentration of the R₁O(CH₂CHOH)ₙR₂ or its salt is 0.2-0.8wt %, preferably 0.5-0.8wt %.

In a specific embodiment, harvesting is performed 3-10 days, preferably 5-7 days, after the defoliant is sprayed.

The second technical problem to be solved by the invention is to provide a defoliant. In order to solve the second technical problem of the invention, the defoliant of the invention contains 0.2-0.8wt %, preferably 0.5-0.8wt %, of the above-mentioned R₁O(CH₂CHOH)ₙR₂ or its salt and agronomically acceptable additives and solvents.

The solvents can be agronomically acceptable solvents, for example, at least one of water, alcohols (methanol, ethanol, isopropanol, n-butyl alcohol, etc.), xylene, trimethylbenzene, and methylated vegetable oils.

In a specific embodiment, the additive includes a defoamer. The ratio of the mass percentage of the R₁O(CH₂CHOH)ₙR₂ or its salt to that of the defoamer is 11-99: 0-2, preferably 50-99: 0.01-0.1.

In a specific embodiment, the defoamer is a silicone defoamer or a polyether defoamer.

The beneficial effects are as follows:

1. The invention provides a new defoliant that starts to deliver defoliation effect 3 days after it is applied. The effect reaches the maximum level at the 7th day, and from the 10th to 20th day, some fruits begin to fall down, so the best time of harvesting is recommended to be 7-10 days after the application. The defoliant is safe and effective, free of pollution risk or pesticide residue, and no harm to the environment and organisms. It can be used in combination with ethephon. A dosage 50% less than the normal use can increase the effect of ripening and defoliation, reducing the consumption of chemical pesticides and environmental pollution;

2. The active constituents according to the invention are readily available. R₁O(CH₂CHOH)ₙR₂ or the salts are commonly seen compounds and frequently used surfactants with good spreading, wetting and permeating effect;

3. R₁O(CH₂CHOH)ₙR₂ or the salts are readily available and cost-effective chemicals. For example, fatty alcohol polyoxyethylene ether is priced at CNY 8000-12000/t, and the cost is CNY 1.6-2.4/20L of water;

4. In case of proper formulation and working conditions, the defoliant can deliver a favorable effect while exerting a minimized influence on the fruit;

5. The defoliant can be used simply by diluting with water to the corresponding working concentration of compounds.

### BRIEF DESCRIPTION OF THE DRAWINGS

FIG. 1 shows the pepper plants of the embodiment and the control group before application according to the invention;

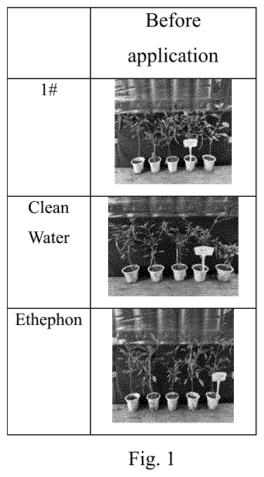

FIG. 2 shows the pepper plants of the embodiment and the control group 3 days after application according to the invention;

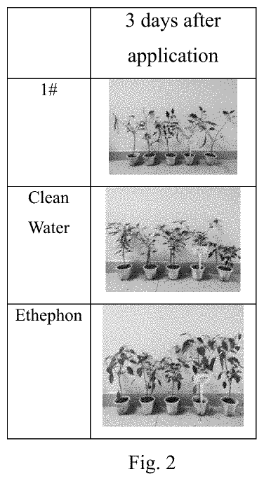

FIG. 3 shows the pepper plants of the embodiment and the control group 5 days after application according to the invention;

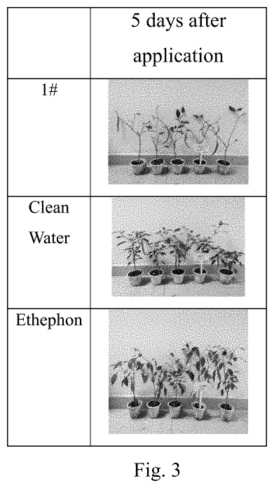

FIG. 4 shows the pepper plants of the embodiment and the control group 7 days after application according to the invention;

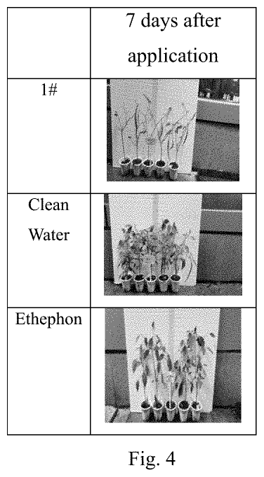

FIG. 5 shows the pepper plants of the embodiment and the control group 20 days after application according to the invention;

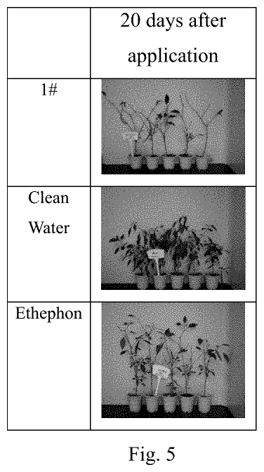

1# refers to C12-C14 fatty alcohol polyoxyethylene (5) ether.

### DETAILED DESCRIPTION OF THE PREFERRED EMBODIMENTS

In order to solve the first technical problem of the invention, at least one of the polyether compound shown in Formula I or salts thereof is used for defoliation.

R₁O(CH₂CHOH)ₙR₂ I

wherein, the R₁ is a hydrocarbyl or a phenolic group;

the R₂ is —H, —O(CH₂CHOH)ₘH or —O(CH₂CH₂CHOH)ₘH;

the n is 1-50, and m is 1-50;

and the salt is preferably a sulphonate or a phosphate.

The salt can be formed based on any position containing a hydroxyl group on R_{O}(CH₂CHOH)ₙR₂.

In a specific embodiment, the cation of the salt is potassium, sodium or ammonium.

In a specific embodiment, the R₁ is a C2-50 hydrocarbyl, preferably a C8-22 hydrocarbyl, and more preferably a C12-18 hydrocarbyl.

In a specific embodiment, the R2 is —H;

or the R₂ is —O(CH₂CHOH)ₘH, wherein, the n is 2-30, m is 1-30; preferably, n is 2-20, m is 1-20; further preferably, n is 3-9, m is 3-9; and more preferably, n is 3, m is 3;

or the R₂ is —O(CH₂CH₂CHOH)ₘH, wherein, the n is 2-30, m is 1-30; preferably, n is 2-20, m is 1-20; further preferably, n is 3-9, m is 3-9; and more preferably, n is 3, m is 3.

In a specific embodiment, the n is 2-30, more preferably 2-20, and further preferably 3-9.

In a specific embodiment, the n is 3, 5, 7 or 9, and preferably 5.

For example, R₁O(CH₂CHOH)₃H, R₁O(CH₂CHOH)₅H, R₁O(CH₂CHOH)₇H or R₁O(CH₂CHOH)₉H. R₁ is a hydroxyl group, for example, R₁ is C12-18.

In a specific embodiment, at least one of R₁O(CH₂CHOH)₃H, R₁O(CH₂CHOH)₇H and R₁O(CH₂CHOH)₉H is used in combination with R₁O(CH₂CHOH)₅H; preferably, R₁O(CH₂CHOH)₇H is used in combination with R₁O(CH₂CHOH)₅H.

At least one of R₁O(CH₂CHOH)₃H, R₁O(CH₂CHOH)₇H and R₁O(CH₂CHOH)₉H is used in combination with R₁O(CH₂CHOH)₅H in any proportion.

In a specific embodiment, the concentration of the R₁O(CH₂CHOH)ₙR₂ or its salt is 0.2-0.8wt %, preferably 0.5-0.8wt %

In a specific embodiment, harvesting is performed 3-10 days, preferably 5-7 days, after the defoliant is sprayed.

In order to solve the second technical problem of the invention, the defoliant of the invention contains 0.2-0.8wt %, preferably 0.5-0.8wt %, of the above-mentioned R₁O(CH₂CHOH)ₙR₂ or its salt and agronomically acceptable additives and solvents.

The solvents can be agronomically acceptable solvents, for example, at least one of water, alcohols (methanol, ethanol, isopropanol, n-butyl alcohol, etc.), xylene, trimethylbenzene, and methylated vegetable oils.

In a specific embodiment, the additive includes a defoamer. The ratio of the mass percentage of the R₁O(CH₂CHOH)ₙR₂ or its salt to that of the defoamer is 11-99: 0-2, preferably 50-99: 0.01-0.1.

In a specific embodiment, the defoamer is a silicone defoamer or a polyether defoamer.

The following description will detail the specific embodiments of the present invention, and the invention will thereby not be limited to the embodiments.

### EMBODIMENT 1

Reagents

C12-C14 fatty alcohol polyoxyethylene (5) ether, purchased from Levima Advanced

### Materials Co., Ltd.

Full branched-chain C12 fatty alcohol polyoxyethylene (5) ether, purchased from Sasol (China) Chemical Co., Ltd.

Straight-chain C12-14 fatty alcohol polyoxyethylene (5) ether, purchased from Sasol (China) Chemical Co., Ltd.

Isomeric C13 fatty alcohol polyoxyethylene (5) ether, purchased from Sasol (China) Chemical Co., Ltd.

Glycol analytical reagent

95% ethanol analytical reagent

Silicone-modified defoamer AF-1501, purchased from FTRT CHEMICAL CO., LTD.

40% ethephon solution, purchased from Sichuan Guoguang Agrochemical Co., Ltd.

The constituents of the defoliant in Embodiment 1 is shown in the Table 1 below:

TABLE 1
Constituents of Defoliant

| Ingredient | Mass percentage |
|---|---|
| Active constituents | 80% |
| Silicone-modified defoamer AF-1501 | 1% |
| Ethylene glycol | 10% |
| 95% ethanol | Topping up to 100% |

1 Test temperature and humidity

10° C.-20° C., 40%˜70%

2 Reagent description and concentration

The defoliant listed in Table 1 is diluted to a certain extent for application. See Table 2 for the active constituents and dilution factor of the defoliant.

TABLE 2
Active Constituents and Dilution Factor

| Treatment No. | Reagents | Dilution factor |
|---|---|---|
| 1 | C12-C14 fatty alcohol | 100X, 160X, 400X |
| | polyoxyethylene (5) ether | |
| 2 | Full branched-chain C12 fatty | 100X, 160X, 400X |
| | alcohol polyoxyethylene (5) ether | |
| 3 | Straight-chain C12-14 fatty | 100X, 160X, 400X |
| | alcohol polyoxyethylene (5) | |
| 4 | Isomeric C13 fatty alcohol | 100X, 160X, 400X |
| | polyoxyethylene (5) ether | |
| 5 | C12-C14 fatty alcohol | 160X + 1400X |
| | polyoxyethylene (5) ether + | |
| | 40% ethephon | |
| 6 | 40% ethephon | 700X |
| 7 | Clean Water | — |

100X, 160X and 400X dilution of the C12-C14 fatty alcohol polyoxyethylene (5) ether refers to 100X, 160X and 400X dilution of the defoliant listed in Table 1 containing an active constituent of C12-C14 fatty alcohol polyoxyethylene (5) ether. 160X+1400X dilution of the C12-C14 fatty alcohol polyoxyethylene (5) ether+40% ethephon refers to 160X dilution of the defoliant listed in Table 1 containing an active constituent of C12-C14 fatty alcohol polyoxyethylene (5) ether and mixture with 40% ethephon subject to 1400X dilution, equivalent to that the mixed solution contains 0.5% of C12-C14 fatty alcohol polyoxyethylene (5) ether and 0.029% of ethephon.

2.2 Plot design

A total of 7 treatment plots (including 1 for control group, with water) are arranged for the test, each including 5 pots.

3 Test method

Spray method. The test reagent is prepared according to the design requirements, and then applied once to each treatment plot by uniformly spraying it onto each pot as per 100 ml/m² of water consumption, while ensuring consistent spray onto each treatment plot and sufficient spray to cover the whole plant.

4 Investigation

4.1 Investigation time and method

Investigating the total number of treated leaves and fruits of each plant before application of the reagent, and 3 days, 5 days, 7 days, 20 days and 25 days after the application, calculating the defoliation rate and observing the influence on fruits.

Adding fixedly 150 ml of water to each pot each time.

4.2 Calculation method

4.2.1 Absolute value (digital measurement) investigation

According to the investigated data, calculating the defoliation rate as per equation (1), in the unit of percentage (%), rounded to two decimal places.

(1) Defoliation rate (%)=(total number of treated leaves—number of remaining leaves)/total number of treated leaves.

(2) Corrected defoliation rate (%)=(defoliation rate of the treatment plot—defoliation rate of the control group)/(1-defoliation rate of the control group)*100.

If the defoliation rate of the control group <5%, correction is not required; otherwise, the result should be corrected as per equation (2).

(3) Fruit abscission rate (%)=(total number of treated fruits—number of remaining fruits)/total number of treated fruits.

5 Test results and analysis

The defoliation effect on the pepper plants is analyzed through comparison of the results of the pots before and after application of the reagent and the control group.

5.1 Test results

TABLE 3
Defoliation Rate of Pepper

| | | | Defoliation | Defoliation | Defoliation | Defoliation | Defoliation |
|---|---|---|---|---|---|---|---|
| | | | rate 3 days | rate 5 days | rate 7 days | rate 20 days | rate 25 days |
| | | Dilution | after appli- | after appli- | after appli- | after appli- | after appli- |
| S/N | Reagents | factor | cation/% | cation/% | cation/% | cation/% | cation/% |
| 1 | C12-C14 fatty alcohol | 100X | 60.03 | 78.72 | 94.97 | 69.9 | 18.42 |
| | polyoxyethylene (5) | 160X | 66.25 | 70.63 | 79.71 | 73.64 | 51.64 |
| | ether | 400X | −1.46 | 4.66 | 14.5 | 26.17 | 17.95 |
| 2 | Full branched-chain | 100X | 72.15 | 87.4 | 100 | 84.33 | 75.8 |
| | C12 fatty alcohol | 160X | 74.69 | 85.12 | 93.59 | 72.18 | 18.07 |
| | polyoxyethylene (5) | 400X | 5.58 | 16.17 | 21.83 | 32.56 | 7.88 |
| | ether | | | | | | |
| 3 | Straight-chain C12-14 | 100X | 54.46 | 68.84 | 86.02 | 69.02 | 35.12 |
| | fatty alcohol | 160X | 38.84 | 43.16 | 64.73 | 56.79 | 35.09 |
| | polyoxyethylene (5) | 400X | 6.99 | 10.84 | 15.88 | 27.07 | 8.36 |
| 4 | Isomeric C13 fatty | 100X | 23.88 | 40.42 | 66.7 | 64.66 | 16.35 |
| | alcohol polyoxyethylene | 160X | 14.35 | 16.59 | 25.25 | 27.79 | 7.78 |
| | (5) ether | 400X | −3.15 | −2.02 | 5.81 | 8.88 | −2.16 |
| 5 | C12-C14 fatty alcohol | 160X + | 90.71 | 94.7 | 100 | 55.88 | 35.75 |
| | polyoxyethylene (5) | 1400X | | | | | |
| | ether + 40% ethephon | | | | | | |
| 6 | 40% ethephon | 700X | 14.09 | 36.48 | 57.09 | 2.39 | −36.74 |
| 7 | Clean Water | — | −0.28 | −3.23 | −8.94 | −10.86 | −29.65 |

TABLE 4
Fruit Abscission Rate of Pepper

| | | | Fruit | Fruit | Fruit | Fruit | Fruit |
|---|---|---|---|---|---|---|---|
| | | | abscission | abscission | abscission | abscission | abscission |
| | | | rate 3 days | rate 5 days | rate 7 days | rate 20 days | rate 25 days |
| | | Dilution | after appli- | after appli- | after appli- | after appli- | after appli- |
| S/N | Reagents | factor | cation/% | cation/% | cation/% | cation/% | cation/% |
| 1 | C12-C14 fatty alcohol | 100X | 10 | 10 | 10 | 50 | 50 |
| | polyoxyethylene (5) | 160X | 5 | 5 | 5 | 16.17 | 26.67 |
| | ether | 400X | 0 | 0 | 6.67 | 21.67 | 21.67 |
| 2 | Full branched-chain | 100X | 20 | 50 | 70 | 100 | 100 |
| | C12 fatty alcohol | 160X | 0 | 2 | 5 | 22.15 | 25.24 |
| | polyoxyethylene (5) | 400X | 0 | 6.67 | −20 | 13.33 | 20 |
| | ether | | | | | | |
| 3 | Straight-chain | 100X | 8 | 21.33 | 28 | 42.67 | 42.67 |
| | C12-14 fatty alcohol | 160X | 0 | 0 | 0 | −90 | 10 |
| | polyoxyethylene (5) | 400X | 10 | 15 | 15 | 25 | 30 |
| 4 | Isomeric C13 fatty | 100X | 0 | 0 | 0 | 60 | 60 |
| | alcohol polyoxyethylene | 160X | 0 | 0 | 0 | 16.67 | 16.67 |
| | (5) ether | 400X | 0 | 0 | −10 | 23.33 | 16.67 |
| 5 | C12-C14 fatty alcohol | 160X + | 61 | 70 | 90 | 100 | 100 |
| | polyoxyethylene (5) | 1400X | | | | | |
| | ether + 40% ethephon | | | | | | |
| 6 | 40% ethephon | 700X | 93.33 | 93.33 | 93.33 | 100 | 100 |
| 7 | Clean Water | — | 0 | 0 | 0 | 6.67 | 6.67 |

1. An application of at least one of a polyether compound shown in Formula I or salts thereof as an active constituent for preparation of a defoliant or a defoliation synergist,
R₁O(CH₂CHOH)ₙR₂ I
wherein, the R₁ is a hydrocarbyl or a phenolic group;
the R₂ is —H, —O(CH₂CHOH)ₘH or —O(CH₂CH₂CHOH)ₘH;
the n is 1-50, and m is 1-50;
and the salt is preferably a sulphonate or a phosphate.

2. The application according to claim 1, wherein the R₁ is a C2-50 hydrocarbyl.

3. The application according to claim 1, wherein the R₂ is —H;
or the R₂ is —O(CH₂CHOH)ₘH, wherein, the n is 2-30, m is 1-30;
or the R2 is —O(CH2CH2CHOH)mH, wherein, the n is 2-30, m is 1-30.

4. The application according to claim 1, wherein the n is 2-30.

5. The application according to claim 1, wherein at least one of the polyether compound shown in Formula I or salts thereof is used for preparation of defoliation synergists, and the defoliant is ethephon.

6. The application according to claim 1, wherein the concentration of the R₁O(CH₂CHOH)ₙR₂ or its salt is 0.2-0.8wt %.

7. The application according to claim 1, wherein harvesting is performed 3-10 days after the defoliant is sprayed.

8. A defoliant, wherein it contains 0.2-0.8wt % , of the above-mentioned R₁O(CH₂CHOH)ₙR₂ or its salt and agronomically acceptable additives and solvents according to claim 1.

9. The defoliant according to claim 8, wherein the additive includes a defoamer, and the ratio of the mass percentage of the R₁O(CH₂CHOH)ₙR₂ or its salt to that of the defoamer is 11-99:0-2.

10. The defoliant according to claim 9, wherein the defoamer is a silicone defoamer or a polyether defoamer.
